(19) United States
(12) Patent Application Publication
(10) Pub. No.: US 2026/0291414 A1
(43) Pub. Date: Sep. 24, 2026

(54) MOTOR CONTROL SYSTEM

(71) Applicants: Kabushiki Kaisha Toshiba, Kanagawa (JP); Toshiba Electronic Devices & Storage Corporation, Kanagawa (JP)

(72) Inventor: Tamotsu Itou, Yokohama Kanagawa (JP)

(21) Appl. No.: 19/303,101

(22) Filed: Aug. 18, 2025

(30) Foreign Application Priority Data
Mar. 21, 2025 (JP) 2025-047436

(51) Int. Cl. H02P 8/12; H02P 8/14; H02P 8/34; H02P 8/38

(52) U.S. Cl. CPC H02P 8/12; H02P 8/14; H02P 8/34; H02P 8/38

(57) ABSTRACT

According to one embodiment, a motor control system includes a motor including a rotor and a coil, an H bridge circuit configured to control current flowing in the coil, a motor control circuit configured to execute PWM (Pulse Width Modulation) constant current control of the H bridge circuit, a time measurement circuit configured to measure a first time in which the H bridge circuit is in a first state, and a first detection circuit configured to detect a low rotation or stop state of the rotor based on a length of the first time.

### CROSS-REFERENCE TO RELATED APPLICATION

This application is based upon and claims the benefit of priority from prior Japanese Patent Application No. 2025-047436, filed Mar. 21, 2025, the entire contents of which are incorporated herein by reference.

### FIELD

Embodiments described herein relate generally to a motor control system.

### BACKGROUND

As control technology of a stepping motor or a DC motor, PWM (Pulse Width Modulation) control technology is known.

### BRIEF DESCRIPTION OF THE DRAWINGS

FIG. 1 is a block diagram illustrating an example of an overall configuration of a motor control system according to a first embodiment.

FIG. 2 is a circuit diagram illustrating an example of a configuration of an H bridge circuit in a driver included in the motor control system according to the first embodiment.

FIG. 3 is a diagram illustrating an example of a configuration of a motor included in the motor control system according to the first embodiment.

FIG. 4 is a diagram illustrating an example of an operation state of the H bridge circuit included in the motor control system according to the first embodiment.

FIG. 5 is a diagram illustrating an example of a current path in a case where the operation state of the H bridge circuit included in the motor control system according to the first embodiment has transitioned.

FIG. 6 is a graph illustrating an example of a relationship between an induction voltage and Slow time of the motor included in the motor control system according to the first embodiment.

FIG. 7 is a diagram illustrating an example of a motor current waveform of PWM constant current control and a variation of the Slow time at a time when a rotor included in the motor control system according to the first embodiment normally rotates.

FIG. 8 is a diagram illustrating an example of a motor current waveform of PWM constant current control and a variation of the Slow time at a time when the rotor included in the motor control system according to the first embodiment is in a low rotation or stop state.

FIG. 9 is a flowchart illustrating an example of a flow of motor control in a case where a rotor low rotation/stop detection circuit included in the motor control system according to the first embodiment detects a low rotation or stop state.

FIG. 10 is a flowchart illustrating an example of a flow of motor control in a case where a rotor low rotation/stop detection circuit included in a motor control system according to a first modification of the first embodiment detects a low rotation or stop state.

FIG. 11 is a flowchart illustrating an example of a flow of motor control in a case where a rotor low rotation/stop detection circuit included in a motor control system according to a second modification of the first embodiment detects a low rotation or stop state.

FIG. 12 is a diagram illustrating an example of a motor current waveform of PWM constant current control and a variation of the Slow time at a time when the rotor included in a motor control system according to a second embodiment vibrates.

FIG. 13 is a flowchart illustrating an example of a flow of motor control in a case where a rotor low rotation/stop detection circuit and a rotor vibration detection circuit included in the motor control system according to the second embodiment detect a low rotation or stop state, and a vibration state.

FIG. 14 is a flowchart illustrating an example of a flow of motor control in a case where a rotor low rotation/stop detection circuit and a rotor vibration detection circuit included in a motor control system according to a first modification of the second embodiment detect a low rotation or stop state, and a vibration state.

FIG. 15 is a flowchart illustrating an example of a flow of motor control in a case where a rotor low rotation/stop detection circuit and a rotor vibration detection circuit included in a motor control system according to a second modification of the second embodiment detect a low rotation or stop state, and a vibration state.

### DETAILED DESCRIPTION

In general, according to one embodiment, a motor control system includes a motor including a rotor and a coil, an H bridge circuit configured to control current flowing in the coil, a motor control circuit configured to execute PWM (Pulse Width Modulation) constant current control of the H bridge circuit, a time measurement circuit configured to measure a first time in which the H bridge circuit is in a first state, and a first detection circuit configured to detect a low rotation or stop state of the rotor based on a length of the first time.

Hereinafter, embodiments are described with reference to the accompanying drawings. In the description below, common reference signs are added to structural elements having identical functions and structures. In addition, in a case of distinguishing structural elements having common reference signs, the structural elements are distinguished by adding additional characters to the common reference signs. If structural elements do not need to be particularly distinguished, only common reference signs are added to the structural elements, and no additional characters are added. Here, the additional characters are not limited to subscripts and superscripts, and include, for example, lowercase alphabet, an index indicating an arrangement, and the like, which are added to ends of reference signs.

### 1. First Embodiment

A motor control system according to a first embodiment is described. Hereinafter, although a case in which a motor is a stepping motor is described, the motor is not limited to the stepping motor.

### 1.1. Configuration

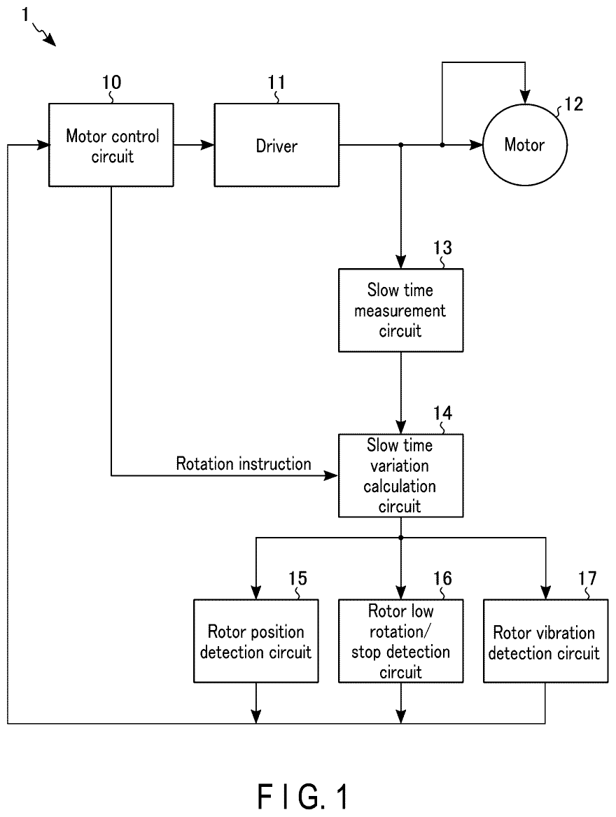

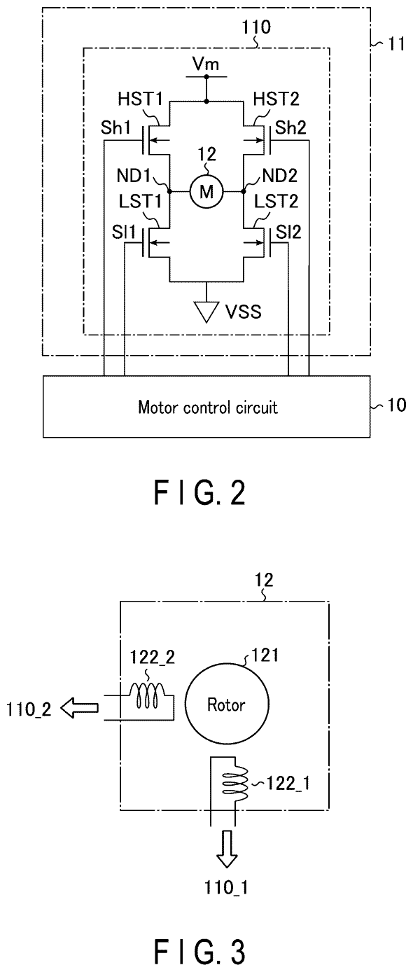

To begin with, referring to FIG. 1 to FIG. 3, an example of a configuration of a motor control system 1 is described. FIG. 1 is a block diagram illustrating an example of an overall configuration of the motor control system 1. FIG. 2 is a circuit diagram illustrating an example of a configuration of an H bridge circuit 110 included in a driver 11. FIG. 3 is a diagram illustrating an example of a configuration of a motor 12. Note that in the example illustrated in FIG. 1, although couplings between components are indicated by arrows, the couplings between the components are not limited to this.

As illustrated in FIG. 1, the motor control system 1 includes a motor control circuit 10, a driver 11, a motor 12, a Slow time measurement circuit 13, a Slow time variation calculation circuit 14, a rotor position detection circuit 15, a rotor low rotation/stop detection circuit 16, and a rotor vibration detection circuit 17. Note that the functions of the Slow time measurement circuit 13, Slow time variation calculation circuit 14, rotor position detection circuit 15, rotor low rotation/stop detection circuit 16, and rotor vibration detection circuit 17 may be implemented by dedicated circuits, or may be implemented by the motor control circuit 10 executing firmware.

The motor control circuit 10 controls the entirety of the motor control system 1. For example, the motor control circuit 10 receives position information of a rotor included in the motor 12 from the rotor position detection circuit 15. The motor control circuit 10 receives a low rotation/stop detection signal of the rotor from the rotor low rotation/stop detection circuit 16. Further, the motor control circuit 10 receives a vibration detection signal of the rotor from the rotor vibration detection circuit 17. The motor control circuit 10 controls the driver 11, based on the position information of the rotor, the low rotation/stop detection signal, and the vibration detection signal. In addition, the motor control circuit 10 sends a rotation instruction, which is used for the control of the motor 12, to the Slow time variation calculation circuit 14.

The driver 11 drives the motor 12, based on the control of the motor control circuit 10.

As illustrated in FIG. 2, the driver 11 includes two H bridge circuits 110 corresponding to two-phase coils of the motor 12. Note that in the example illustrated in FIG. 2, for the purpose of simple description, one H bridge circuit 110 is illustrated.

The H bridge circuit 110 generates current for driving the motor 12. The H bridge circuit 110 includes high-side transistors HST1 and HST2 and low-side transistors LST1 and LST2. Note that the high-side transistor is also referred to as “high-side switch”. The low-side transistor is also referred to as “low-side switch”. For example, the high-side transistors HST1 and HST2 and low-side transistors LST1 and LST2 are n-channel power MOS (metal-oxide-semiconductor) transistors. Hereinafter, one of the drain and the source of a transistor is referred to as “one end of the transistor”, and the other of the drain and the source is referred to as “the other end of the transistor”.

One end of the high-side transistor HST1 is coupled to a power supply (power supply voltage line) Vm. The other end of the high-side transistor HST1 is coupled to a node ND1. The node ND1 is coupled to one end of a coil 122 included in the motor 12. The gate of the high-side transistor HST1 is coupled to the motor control circuit 10, and a signal Sh1 is input to the gate of the high-side transistor HST1.

One end of the high-side transistor HST2 is coupled to the power supply Vm. The other end of the high-side transistor HST2 is coupled to a node ND2. The node ND2 is coupled to the other end of the coil 122 included in the motor 12. The gate of the high-side transistor HST2 is coupled to the motor control circuit 10, and a signal Sh2 is input to the gate of the high-side transistor HST2.

One end of the low-side transistor LST1 is coupled to the node ND1. The other end of the low-side transistor LST1 is coupled to the other end of the low-side transistor LST2 and to a ground voltage line (a ground voltage VSS is applied to the other end of the low-side transistor LST1). The gate of the low-side transistor LST1 is coupled to the motor control circuit 10, and a signal Sl1 is input to the gate of the low-side transistor LST1.

One end of the low-side transistor LST2 is coupled to the node ND2. The other end of the low-side transistor LST2 is coupled to the other end of the low-side transistor LST1 and to the ground voltage line (the ground voltage VSS is applied to the other end of the low-side transistor LST2). The gate of the low-side transistor LST2 is coupled to the motor control circuit 10, and a signal Sl2 is input to the gate of the low-side transistor LST2.

As a control method of the H bridge circuit 110, the motor control circuit 10 executes constant current control that is controlled by a current ripple ratio. The motor control circuit 10 sends the signals Sh1, Sh2, Sl1, and Sl2 to the H bridge circuit 110. The signals Sh1, Sh2, Sl1, and Sl2 are PWM signals having variable duties.

The motor 12 is, for example, a stepping motor. The motor 12 is applied to a game machine, a printer, a computer, a digital camera, an industrial robot, or the like.

As illustrated in FIG. 3, the motor 12 includes a rotor 121, a first-phase coil 122_1, and a second-phase coil 122_2. Hereinafter, in a case where the first-phase coil 122_1 and the second-phase coil 122_2 are not distinctly specified, these coils are simply referred to as “coil 122”. The first-phase coil 122_1 and the second-phase coil 122_2 are provided on an outer peripheral side of the rotor 121, respectively. The first-phase coil 122_1 and the second-phase coil 122_2 are coupled to different H bridge circuits 110. Hereinafter, in a case where the H bridge circuit 110, which is coupled to the first-phase coil 122_1, is specified, this H bridge circuit is referred to as “H bridge circuit 110_1”. In a case where the H bridge circuit 110, which is coupled to the second-phase coil 122_2, is specified, this H bridge circuit is referred to as “H bridge circuit 110_2”.

As illustrated in FIG. 1, the Slow time measurement circuit 13 measures a length of a period in which the H bridge circuit 110 is in a slow decay state (hereinafter, this period is referred to as “Slow time”). The slow decay state is a state in which the current flowing in the coil 122 of the motor 12 that is being driven (hereinafter, this current is also referred to as “motor current”) attenuates relatively gently. For example, the Slow time measurement circuit 13 measures the Slow time, based on the operation state of the H bridge circuit (signals Sh1, Sh2, Sl1, and Sl2). Note that the Slow time measurement circuit 13 may measure (calculate) the Slow time, from an induction voltage of the motor 12. The Slow time measurement circuit 13 sends the measurement result of the Slow time to the Slow time variation calculation circuit 14.

The Slow time variation calculation circuit 14 calculates a variation of the Slow time during a 1-step operation of the rotor 121, based on the rotation instruction received from the motor control circuit 10 and the measurement result of the Slow time received from the Slow time measurement circuit 13. The Slow time variation calculation circuit 14 sends information relating to a variation of the Slow time in the 1-step period to the rotor position detection circuit 15, rotor low rotation/stop detection circuit 16, and rotor vibration detection circuit 17.

The rotor position detection circuit 15 calculates a variation of the induction voltage and a zero-cross position of the induction voltage of the motor 12. The zero-cross position of the induction voltage is a position at which the induction voltage inverts from plus to minus, or from minus to plus. The rotor position detection circuit 15 calculates the position of the rotor 121, based on the information of the zero-cross position of the induction voltage. The rotor position detection circuit 15 sends the position information of the rotor 121 to the motor control circuit 10.

The rotor low rotation/stop detection circuit 16 determines, whether the rotor 121 is in a low rotation or stop state, based on the variation of the Slow time during the 1-step period. In a case where the rotor low rotation/stop detection circuit 16 determines that the rotor 121 is in the low rotation or stop state, the rotor low rotation/stop detection circuit 16 sends a low rotation/stop detection signal to the motor control circuit 10.

The rotor vibration detection circuit 17 determines whether the rotor 121 is in a vibration state, that is, in an out-of-step state, based on the variation of the Slow time during the 1-step period. The out-of-step state is a state in which the rotation of the rotor 121 cannot be synchronized with the control of the motor control circuit 10. There is a case where the rotor 121 enters the out-of-step state because the number of revolutions of the rotor 121 decreases or the rotor 121 stops, for example, due to an external load. In a case where the rotor vibration detection circuit 17 determines that the rotor 121 is in the vibration state, the rotor vibration detection circuit 17 sends a vibration detection signal to the motor control circuit 10.

### 1.2. Operation State of H Bridge Circuit

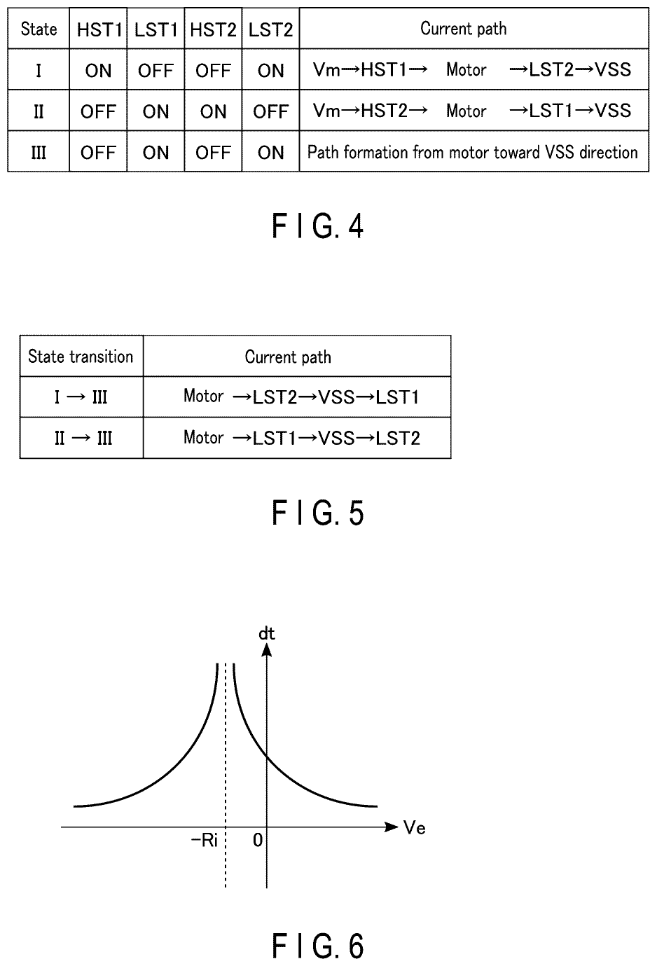

Next, referring to FIG. 4 and FIG. 5, the operation state of the H bridge circuit 110 is described. FIG. 4 is a diagram illustrating an example of an operation state of the H bridge circuit 110. FIG. 5 is a diagram illustrating an example of a current path in a case where the operation state of the H bridge circuit 110 has transitioned.

To begin with, each of operation states of the H bridge circuit 110 is described.

As illustrated in FIG. 4, the operation of the H bridge circuit 110 includes three operation states.

Operation states I and II are modes in which current is supplied to the motor (coil 122). The operation state I and the operation state II are different with respect to the direction of the supply of current to the coil 122. Hereinafter, each of the operation states I and II is also referred to “Charge state”.

For example, in the case of the operation state I, the high-side transistor HST1 and the low-side transistor LST2 are set in an ON state, and the high-side transistor HST2 and the low-side transistor LST1 are set in an OFF state. Thereby, current is supplied from the power supply Vm to the motor 12 (coil 122) via the high-side transistor HST1 and the node ND1. The current supplied to the motor 12 (coil 122) flows to the ground voltage line (voltage VSS side) via the node ND2 and the low-side transistor LST2. That is, the current flows from the node ND1 toward the node ND2.

For example, in the case of the operation state II, the high-side transistor HST2 and the low-side transistor LST1 are set in the ON state, and the high-side transistor HST1 and the low-side transistor LST2 are set in the OFF state. Thereby, current is supplied from the power supply Vm to the motor 12 (coil 122) via the high-side transistor HST2 and the node ND2. The current supplied to the motor 12 (coil 122) flows to the ground voltage line via the node ND1 and the low-side transistor LST1. That is, the current flows from the node ND2 toward the node ND1. For example, in a case where the rotational direction of the rotor 121 in the operation state I is assumed to be the direction of forward rotation, the rotational direction of the rotor 121 in the operation state II is the direction of reverse rotation.

An operation state III is a mode in which the current supplied to the motor 12 (coil 122) is attenuated. That is, the operation state III is a slow decay state. For example, the Slow time measurement circuit 13 measures the length of time in the operation state III.

For example, in the case of the operation state III, the high-side transistor HST1 and the high-side transistor HST2 are set in the OFF state, and the low-side transistor LST1 and the low-side transistor LST2 are set in the ON state. In the operation state III, a loop of a current path is formed by the motor 12 (coil 122), low-side transistor LST1, and low-side transistor LST2. The operation state III is a state in which current is regenerated on the low-side transistor LST side. The charge stored in the coil 122 is discharged, and current flows to the ground voltage line side. Note that in the operation state III, the high-side transistor HST1 and the high-side transistor HST2 may be set in the ON state, and the low-side transistor LST1 and the low-side transistor LST2 may be set in the OFF state. In this case, a loop of a current path is formed by the motor 12 (coil 122), high-side transistor HST1, and high-side transistor HST2.

Note that in the case where the high-side transistor HST1 and the low-side transistor LST1 are set in the ON state at the same time, and in the case where the high-side transistor HST2 and the low-side transistor LST2 are set in the ON state at the same time, a large current (through-current) flows from the power supply Vm to the ground voltage VSS side. Thus, the case where the high-side transistor HST1 and the low-side transistor LST1 are set in the ON state at the same time, and the case where the high-side transistor HST2 and the low-side transistor LST2 are set in the ON state at the same time, are not set as operation modes.

Next, a description is given of a case where the operation state I or the operation state II transitions to the operation state III.

As illustrated in FIG. 5, for example, if the operation state I transitions to the operation state III, current flows from the motor 12 to the low-side transistor LST2 side by the energy stored in the coil 122. Current flows from the node ND1 to the node ND2 side in a loop of a current path by the motor 12, low-side transistor LST1, and low-side transistor LST2.

In addition, if the operation state II transitions to the operation state III, current flows from the motor 12 to the low-side transistor LST1 side by back electromotive force. Current flows from the node ND2 to the node ND1 side in a loop of a current path by the motor 12, low-side transistor LST1, and low-side transistor LST2.

### 1.3. Variation of Slow Time in Normal Rotation State and Low Rotation/Stop State

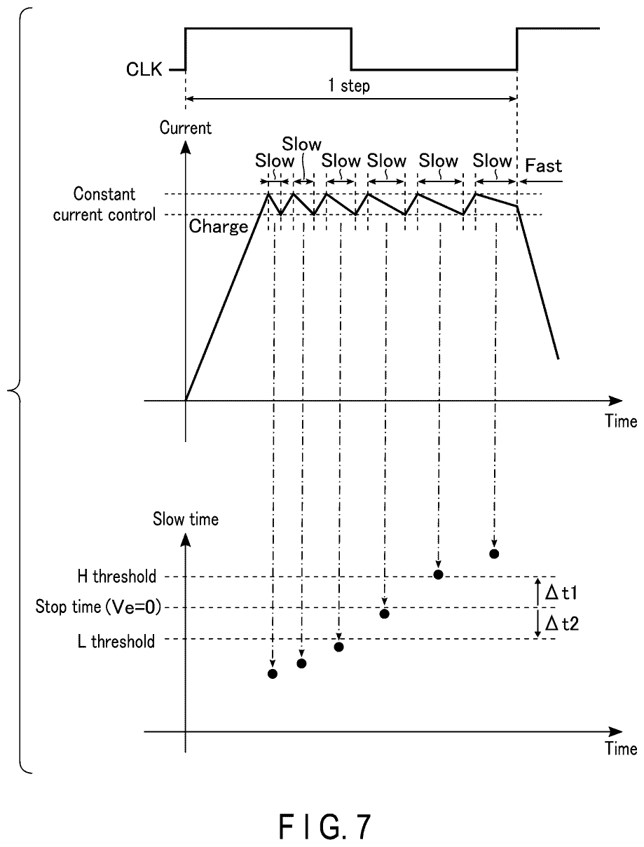

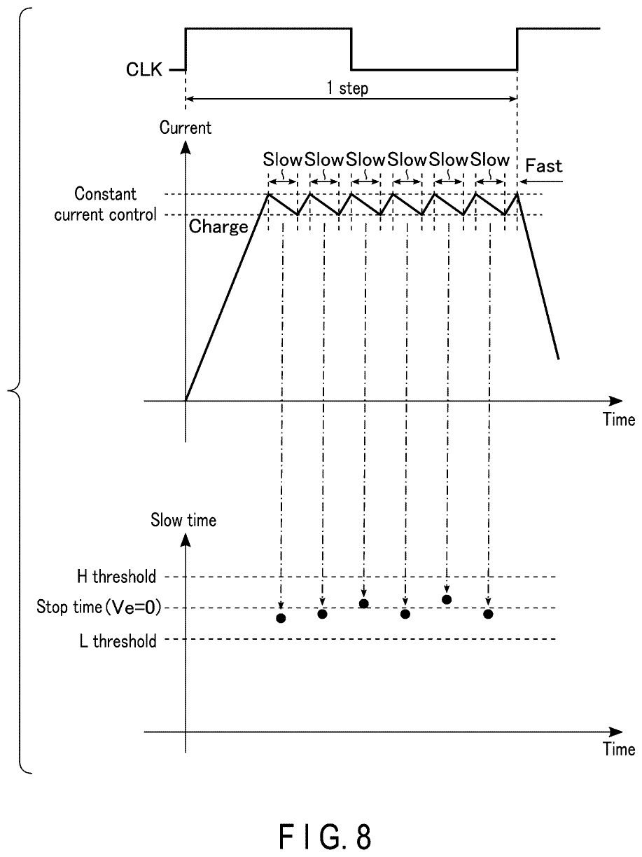

Next, referring to FIG. 6 to FIG. 9, a description is given of an example of the variation of the Slow time in a case where the rotor 121 is in a normal rotation state and in a low rotation/stop state. FIG. 6 is a graph illustrating an example of a relationship between an induction voltage and a Slow time of the motor 12. FIG. 7 is a diagram illustrating an example of a motor current waveform of PWM constant current control and a variation of the Slow time at a time when the rotor 121 normally rotates. FIG. 8 is a diagram illustrating an example of a motor current waveform of PWM constant current control and a variation of the Slow time at a time when the rotor 121 is in a low rotation or stop state.

As illustrated in FIG. 6, in the case of constant current control that is controlled by a current ripple ratio, the length of the Slow time of PWM control (i.e., the period of the operation state III) varies depending on an induction voltage. For example, in a case where the Slow time is dt, the induction voltage is Ve, a resistance component of the motor 12 is R, and the motor current is i, the Slow time dt becomes maximum at a time when Ve=−Ri. In addition, at a time when the rotor 121 is in a stop state (Ve=0), the Slow time dt takes a decreasing curve passing through dt>0, and successively varies.

The Slow time dt at a time when the rotor 121 is in the stop state (Ve=0) is expressed by expression (1) by linear approximation.

$$d t = ( L / R ) \times di \qquad ( 1 )$$

Here, dt is the Slow time, L is an inductor component of the motor 12, R is a resistance component of the motor 12, and di is a variation ratio of motor current (a current ripple ratio in a slow decay state).

To begin with, a state in which the rotor 121 normally rotates is described.

As illustrated in an upper part of FIG. 7, during a 1-step period, a region where the motor current is increasing corresponds to a Charge region. In the constant current control state, a region where the motor current is decreasing corresponds to a slow decay state (Slow time). A region where the motor current rapidly decreases after the 1-step period corresponds to a fast decay state. The fast decay state is a state in which the motor current attenuates more rapidly than in the slow decay state.

As illustrated in a lower part of FIG. 7, for example, the Slow time at a time when the rotor 121 stops, that is, an approximate value of expression (1), is set as a center, and an upper limit value of a threshold range for determining whether the rotor 121 is in a low rotation or stop state is defined as “H threshold”. Similarly, a lower limit value of the threshold range for determining whether the rotor 121 is in the low rotation or stop state is defined as “L threshold”. For example, if an upper-side width in relation to the Slow time ((L/R)×di) at the time when the rotor 121 stops is Δt1, the H threshold is calculated as (L/R)×di+Δt1. In addition, if a lower-side width in relation to the Slow time ((L/R)×di) at the time when the rotor 121 stops is Δt2, the L threshold is calculated as (L/R)×di−Δt2. That is, the width of the threshold range is Δt1+Δt2. Note that the width Δt1 and the width Δt2 may have equal values or different values.

In a case where the rotor 121 normally rotates, a minimum Slow time during the 1-step period is shorter than the L threshold, and a maximum Slow time is longer than the H threshold. A variation of the Slow time during the 1-step period crosses the Slow time in the state in which the rotor 121 stops (the induction voltage Ve=0), and changes successively.

Next, a state in which the rotor 121 is in the low rotation or stop state is described.

As illustrated in FIG. 8, in the case where the rotor 121 is in the low rotation or stop state, each Slow time during the 1-step period is within the threshold range. That is, each Slow time during the 1-step period is longer than the L threshold and is shorter than the H threshold. The rotor low rotation/stop detection circuit 16 determines that the rotor 121 is in the low rotation or stop state, if each Slow time during the 1-step period is within the threshold range. In this case, the rotor low rotation/stop detection circuit 16 outputs a low rotation/stop detection signal.

### 1.4. Flow of Motor Control in Case of Detecting Low Rotation or Stop State

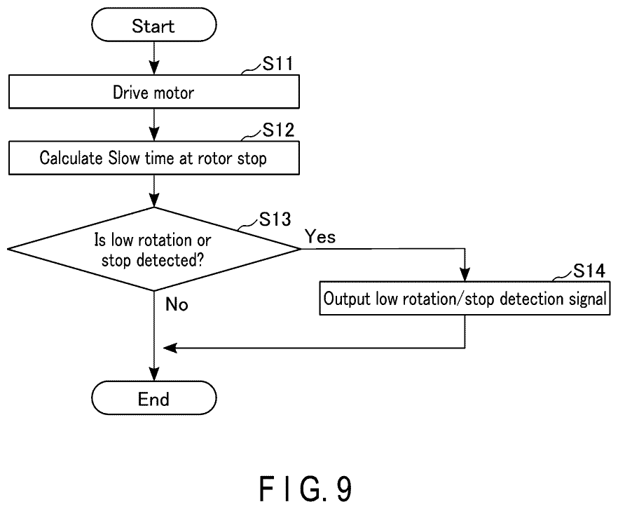

Next, referring to FIG. 9, a description is given of an example of a flow of motor control in a case where the rotor low rotation/stop detection circuit 16 detects a low rotation or stop state. FIG. 9 is a flowchart illustrating an example of a flow of motor control in a case where the rotor low rotation/stop detection circuit 16 detects the low rotation or stop state.

As illustrated in FIG. 9, to begin with, the motor control circuit 10 drives the motor 12 (S11). More specifically, the motor control circuit 10 rotates the rotor 121 by controlling the driver 11, that is, the H bridge circuit 110. The Slow time measurement circuit 13 measures the length of each Slow time. The Slow time measurement circuit 13 sends a measurement result to the Slow time variation calculation circuit 14.

The Slow time variation calculation circuit 14 executes an arithmetic operation of expression (1) and calculates the Slow time (or an approximate value of Slow time) in the state in which the rotor 121 stops (induction volage Ve=0) (S12). The Slow time variation calculation circuit 14 sets the threshold range (H threshold and L threshold), based on the calculated Slow time at the time when the rotor 121 stops. In addition, the Slow time variation calculation circuit 14 calculates a variation of the Slow time during the 1-step period. The Slow time variation calculation circuit 14 sends the calculation result to the rotor low rotation/stop detection circuit 16.

The rotor low rotation/stop detection circuit 16 determines whether the rotor 121 is in a low rotation or stop state. That is, the rotor low rotation/stop detection circuit 16 determines whether the Slow time is within the threshold range during the 1-step period. In a case where the low rotation or stop state of the rotor 121 is detected (S13_Yes), that is, in a case where each Slow time is within the threshold range during the 1-step period, the rotor low rotation/stop detection circuit 16 determines that the rotor 121 is in the low rotation or stop state, and outputs a low rotation/stop detection signal (S14). The motor control circuit 10, which has received the low rotation/stop detection signal, issues a notification that the low rotation or stop state was detected, for example, to the outside.

In a case where the low rotation or stop state is not detected (S13_No), that is, in a case where each Slow time is not within the threshold range during the 1-step period, the motor control circuit 10 determines that the rotation of the rotor 121 was normal rotation, and finishes the driving control of the motor 12.

According to the configuration of the present embodiment, the motor control system 1 includes the rotor low rotation/stop detection circuit 16. The rotor low rotation/stop detection circuit 16 can detect the low rotation or stop state of the rotor 121, based on the variation of the Slow time during the 1-step period. Thereby, even in a case where the rotor 121 enters the low rotation or stop state due to, for example, the influence of an external load, the motor control system 1 can automatically detect the low rotation or stop state of the rotor 121, even without setting, from the outside, the number of revolutions at which the rotor position cannot be detected.

### 1.5. Modifications of First Embodiment

Next, two modifications of the first embodiment are described. Hereinafter, different points from the first embodiment are mainly described.

### 1.5.1. First Modification of First Embodiment

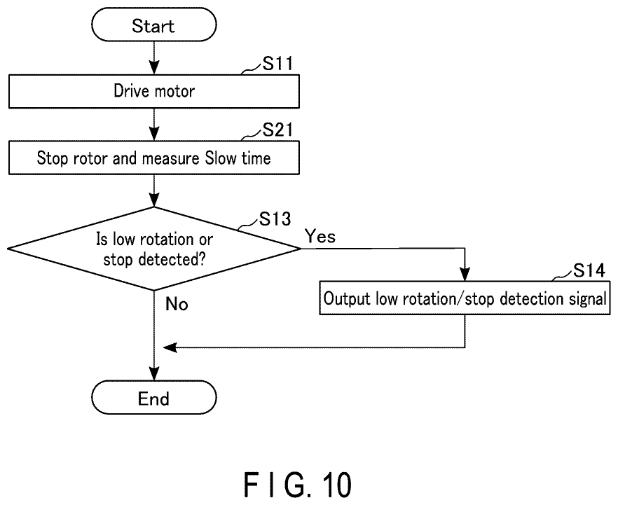

To begin with, referring to FIG. 10, a first modification of the first embodiment is described. In the present modification, a case is described in which, instead of calculating the Slow time at the time when the rotor 121 stops, constant current control is executed in the state in which the rotor 121 is stopped, and the Slow time at this time is measured. FIG. 10 is a flowchart illustrating an example of a flow of motor control in a case where the rotor low rotation/stop detection circuit 16 detects a low rotation or stop state.

As illustrated in FIG. 10, to begin with, the motor control circuit 10 drives the motor 12 (S11). More specifically, the motor control circuit 10 rotates the rotor 121 by controlling the driver 11, that is, the H bridge circuit 110. The Slow time measurement circuit 13 measures the length of each Slow time. The Slow time measurement circuit 13 sends a measurement result to the Slow time variation calculation circuit 14.

The motor control circuit 10 executes constant current control in the state in which the rotation of the rotor 121 is stopped. The Slow time measurement circuit 13 measures the length of the Slow time in the stop state (S21). The Slow time variation calculation circuit 14 sets the threshold range (H threshold and L threshold), based on the measured Slow time at the time when the rotor 121 stops. In addition, the Slow time variation calculation circuit 14 calculates a variation of the Slow time during the 1-step period. The Slow time variation calculation circuit 14 sends the calculation result to the rotor low rotation/stop detection circuit 16. Note that step S21 may be executed before step S11.

The rotor low rotation/stop detection circuit 16 determines whether the rotor 121 is in a low rotation or stop state. That is, the rotor low rotation/stop detection circuit 16 determines whether the Slow time is within the threshold range during the 1-step period. In a case where the low rotation or stop state of the rotor 121 is detected (S13_Yes), that is, in a case where each Slow time is within the threshold range during the 1-step period, the rotor low rotation/stop detection circuit 16 determines that the rotor 121 is in the low rotation or stop state, and outputs a low rotation/stop detection signal (S14). The motor control circuit 10, which has received the low rotation/stop detection signal, issues a notification that the low rotation or stop state was detected, for example, to the outside.

In a case where the low rotation or stop state is not detected (S13_No), that is, in a case where each Slow time is not within the threshold range during the 1-step period, the motor control circuit 10 determines that the rotation of the rotor 121 was normal rotation, and finishes the driving control of the motor 12.

According to the configuration of the present modification, the same advantageous effects as in the first embodiment can be obtained.

### 1.5.2. Second Modification of First Embodiment

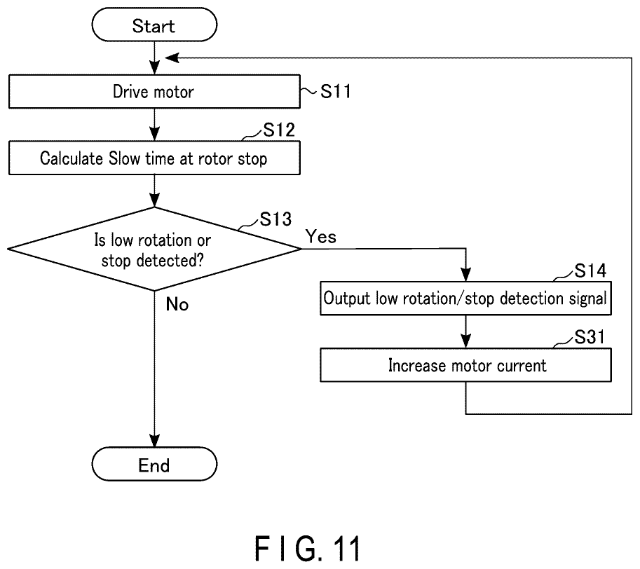

Next, referring to FIG. 11, a second modification of the first embodiment is described. In the present modification, a description is given of a flow of motor control in a case where, if the low rotation or stop state of the rotor 121 is detected, the motor current is increased to restore the rotation of the rotor 121. FIG. 11 is a flowchart illustrating an example of a flow of motor control in a case where the rotor low rotation/stop detection circuit 16 detects a low rotation or stop state.

As illustrated in FIG. 11, the flow from step S11 to step S14 is the same as described with reference to FIG. 9 of the first embodiment.

Upon receiving the low rotation/stop detection signal, the motor control circuit 10 increases a set value of the motor current (S31), and advances to step S11 to drive the motor 12 once again.

According to the configuration of the present modification, the same advantageous effects as in the first embodiment can be obtained. Furthermore, according to the configuration of the present modification, the motor control circuit 10 can automatically increase the motor current so that the rotor 121 may not enter the low rotation or stop state, in a case where the control number of revolutions of the rotor 121 was decreased. Thereby, it is possible to detect the case in which the number of revolutions of the rotor 121 lowers or the rotor 121 stops due to an external load, and to restore the number of revolutions of the rotor 121. Therefore, the reliability of the motor control can be improved.

In addition, the present modification can be combined with the first modification of the first embodiment. That is, the constant current control may be executed in the state in which the rotor 121 is stopped, and the Slow time at this time may be measured.

### 2. Second Embodiment

Next, a second embodiment is described. In the second embodiment, a description is given of an example of a flow of motor control in a case of detecting a low rotation or stop state, and a vibration state. Hereinafter, different points from the first embodiment are mainly described.

### 2.1. Variation of Slow Time in Vibration State

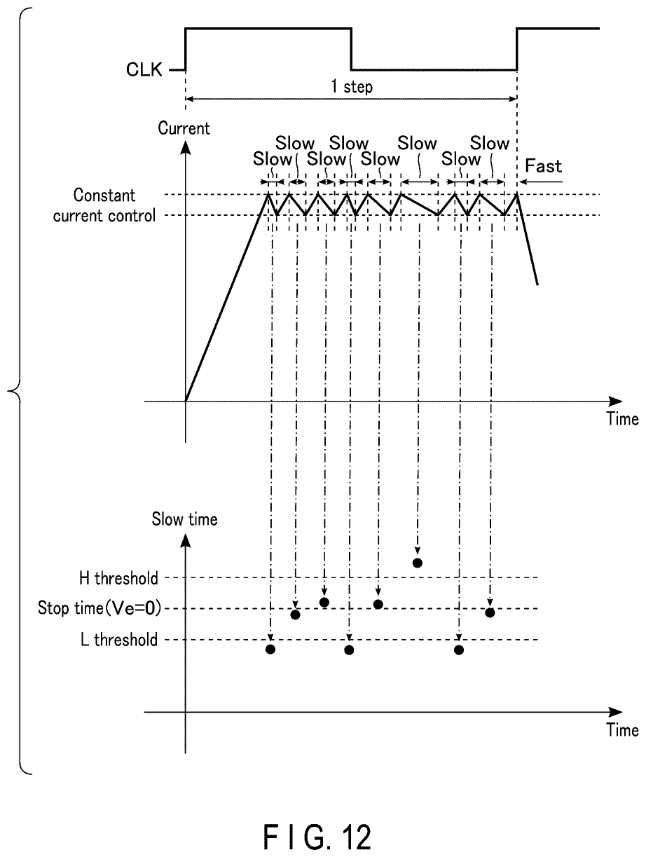

To begin with, referring to FIG. 12, a description is given of an example of the variation of the Slow time in a case where the rotor 121 is in the vibration state. FIG. 12 is a diagram illustrating an example of a motor current waveform of PWM constant current control and a variation of the Slow time at a time when the rotor vibrates.

As illustrated in FIG. 12, in a case where the rotor 121 is out of step and vibrates, the Slow time varies irregularly during the 1-step period. For example, such an up-and-down fluctuation that two mutually neighboring Slow times are present within a threshold range and outside the threshold range, respectively, is repeated two or more times during the 1-step period. The rotor vibration detection circuit 17 determines that the rotor 121 is in the vibration state, in a case where such an up-and-down fluctuation that two mutually neighboring Slow times are present within the threshold range and outside the threshold range, respectively, is repeated two or more times during the 1-step period. In this case, the rotor vibration detection circuit 17 outputs a vibration detection signal.

### 2.2. Flow of Motor Control in Case of Detecting Low Rotation or Stop State, and Vibration State

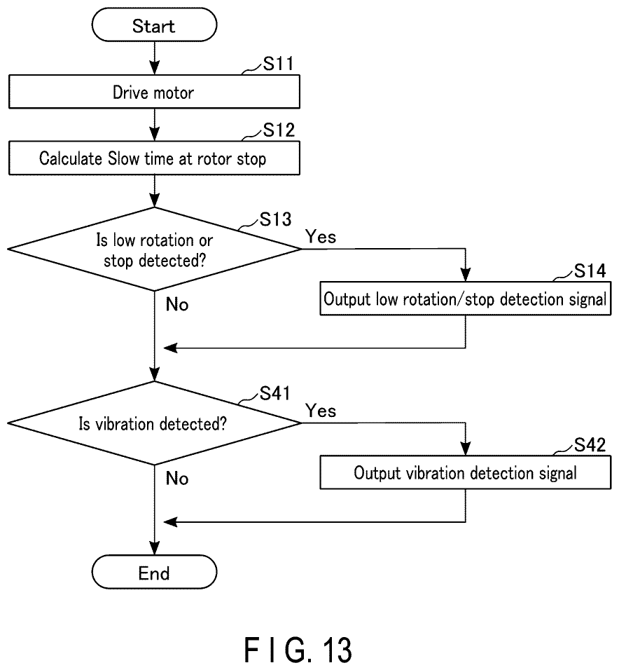

Next, referring to FIG. 13, a description is given of an example of a flow of motor control in a case where the rotor low rotation/stop detection circuit 16 and the rotor vibration detection circuit 17 detect a low rotation or stop state, and a vibration state. FIG. 13 is a flowchart illustrating an example of a flow of motor control in a case where the rotor low rotation/stop detection circuit 16 and the rotor vibration detection circuit 17 detect the low rotation or stop state, and the vibration state.

As illustrated in FIG. 13, the flow from step S11 to step S14 is the same as described with reference to FIG. 9 of the first embodiment.

In a case where the rotor 121 is not in the low rotation or stop state (S13_No), the rotor vibration detection circuit 17 determines whether the rotor 121 is in the vibration state. Note that the determination operation in the rotor vibration detection circuit 17 may be executed before the determination operation in the rotor low rotation/stop detection circuit 16, or may be executed in parallel with the determination operation in the rotor low rotation/stop detection circuit 16.

In a case where the vibration state of the rotor 121 is detected (S41_Yes), that is, in a case where such an up-and-down fluctuation that two mutually neighboring Slow times are present within the threshold range and outside the threshold range, respectively, is repeated two or more times during the 1-step period, the rotor vibration detection circuit 17 determines that the rotor 121 is in the vibration state, and outputs a vibration detection signal (S42). The motor control circuit 10, which has received the vibration detection signal, issues a notification that the vibration (out-of-step state) was detected, for example, to the outside.

In a case where the vibration state of the rotor 121 is not detected (S41_No), that is, in a case where such an up-and-down fluctuation that two mutually neighboring Slow times are present within the threshold range and outside the threshold range, respectively, is not repeated two or more times during the 1-step period, the motor control circuit 10 determines that the rotation of the rotor 121 was normal rotation, and finishes the driving control of the motor 12.

According to the configuration of the present embodiment, the same advantageous effects as in the first embodiment can be obtained.

Furthermore, according to the configuration of the present embodiment, the motor control system 1 includes the rotor vibration detection circuit 17. The rotor vibration detection circuit 17 can detect the vibration state of the rotor 121, based on the variation of the Slow time during the 1-step period. Thereby, in a case where the rotor 121 enters an out-of-step state due to, for example, the influence of an external load, the motor control system 1 can detect the vibration (out-of-step) state.

### 2.3. Modifications of Second Embodiment

Next, two modifications of the second embodiment are described. Hereinafter, different points from the second embodiment are mainly described.

### 2.3.1. First Modification of Second Embodiment

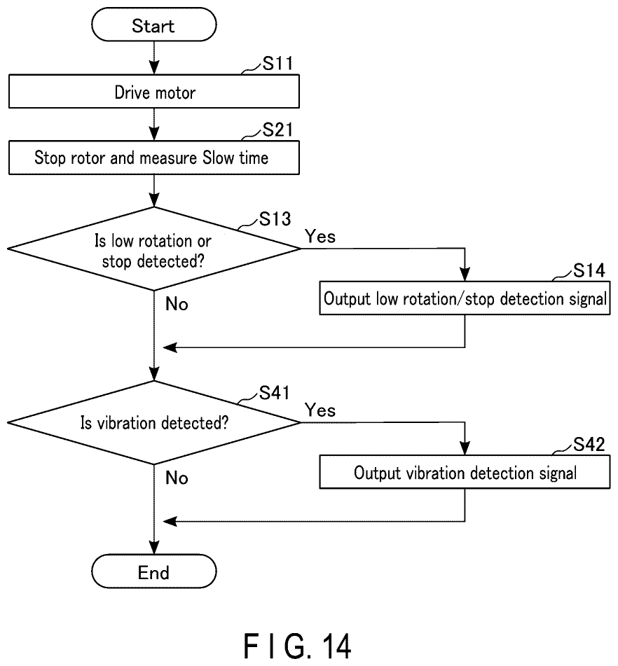

To begin with, referring to FIG. 14, a first modification of the second embodiment is described. In the present modification, a case is described in which, instead of calculating the Slow time at the time when the rotor 121 stops, constant current control is executed in the state in which the rotor 121 is stopped, and the Slow time at this time is measured. FIG. 14 is a flowchart illustrating an example of a flow of motor control in a case where the rotor low rotation/stop detection circuit 16 and rotor vibration detection circuit 17 detect a low rotation or stop state, and a vibration state.

As illustrated in FIG. 14, to begin with, the motor control circuit 10 drives the motor 12 (S11). More specifically, the motor control circuit 10 rotates the rotor 121 by controlling the driver 11, that is, the H bridge circuit 110. The Slow time measurement circuit 13 measures the length of each Slow time. The Slow time measurement circuit 13 sends a measurement result to the Slow time variation calculation circuit 14.

The motor control circuit 10 executes constant current control in the state in which the rotation of the rotor 121 is stopped. The Slow time measurement circuit 13 measures the length of the Slow time in the stop state (S21). The Slow time variation calculation circuit 14 sets the threshold range (H threshold and L threshold), based on the measured Slow time at the time when the rotor 121 stops. In addition, the Slow time variation calculation circuit 14 calculates a variation of the Slow time during the 1-step period. The Slow time variation calculation circuit 14 sends the calculation result to the rotor low rotation/stop detection circuit 16.

The operation of step S13 onwards is the same as described with reference to FIG. 13 of the second embodiment.

According to the configuration of the present modification, the same advantageous effects as in the second embodiment can be obtained.

### 2.3.2. Second Modification of Second Embodiment

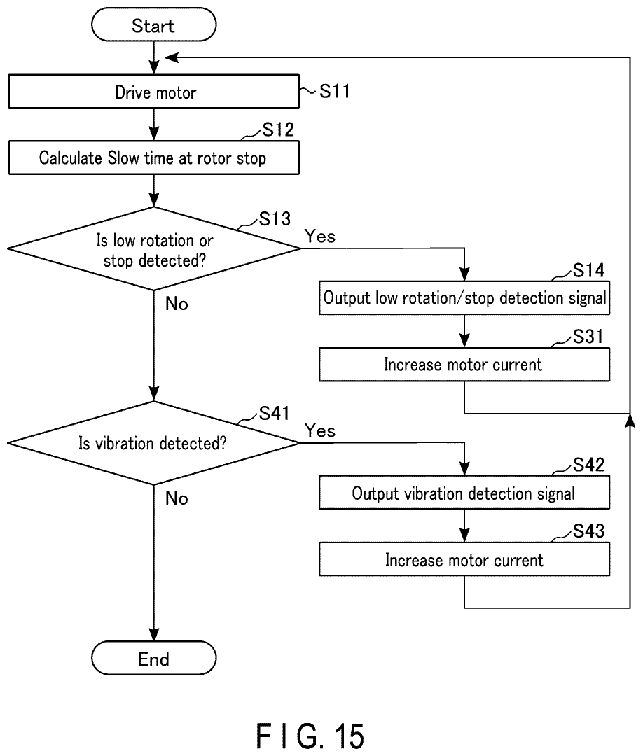

Next, referring to FIG. 15, a second modification of the second embodiment is described. In the present modification, a description is given of a flow of motor control in a case where, if the vibration state of the rotor 121 is detected, the motor current is increased to restore the rotation of the rotor 121. FIG. 15 is a flowchart illustrating an example of a flow of motor control in a case where the rotor low rotation/stop detection circuit 16 and rotor vibration detection circuit 17 detect a low rotation or stop state, and a vibration state.

As illustrated in FIG. 15, the flow from step S11 to step S31 is the same as described with reference to FIG. 11 of the second modification of the first embodiment.

In a case where the rotor 121 is not in the low rotation or stop state (S13_No), the rotor vibration detection circuit 17 determines whether the rotor 121 is in the vibration state. Note that the determination operation in the rotor vibration detection circuit 17 may be executed before the determination operation in the rotor low rotation/stop detection circuit 16, or may be executed in parallel with the determination operation in the rotor low rotation/stop detection circuit 16.

In a case where the vibration state of the rotor 121 is detected (S41_Yes), that is, in a case where such an up-and-down fluctuation that two mutually neighboring Slow times are present within the threshold range and outside the threshold range, respectively, is repeated two or more times during the 1-step period, the rotor vibration detection circuit 17 determines that the rotor 121 is in the vibration state, and outputs a vibration detection signal (S42).

Upon receiving the vibration detection signal, the motor control circuit 10 increases a set value of the motor current (S43), and advances to step S11 to drive the motor 12 once again.

According to the configuration of the present modification, the same advantageous effects as in the second embodiment can be obtained. Furthermore, according to the configuration of the present modification, the motor control circuit 10 can automatically increase the motor current so that the rotor 121 may not enter the out-of-step state, in a case where the control number of revolutions of the rotor 121 was decreased. Thereby, it is possible to detect the case in which the number of revolutions of the rotor 121 enters the out-of-step due to an external load, and to restore the rotation. Therefore, the reliability of the motor control can be improved.

In addition, the present modification can be combined with the first modification of the second embodiment. Specifically, the constant current control may be executed in the state in which the rotor 121 is stopped, and the Slow time at this time may be measured.

### 3. Modifications, Etc.

The motor control system according to the above embodiments includes a motor (12) including a rotor (121) and a coil (122), an H bridge circuit (110) configured to control current flowing in the coil, a motor control circuit (10) configured to execute PWM (Pulse Width Modulation) constant current control of the H bridge circuit, a time measurement circuit (13) configured to measure a first time (Slow time) in which the H bridge circuit is in a first state (slow decay), and a first detection circuit (16) configured to detect a low rotation or stop state of the rotor based on a length of the first time.

According to the configuration of the above-described embodiments, the low rotation or stop state and the out-of-step state of the motor can be detected.

Note that, aside from the above-described embodiments, various modifications are applicable.

Besides, the meaning of the term “coupling” in the above-described embodiments includes a state of indirect coupling, for example, with some element, such as a transistor or a resistor, being interposed.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A motor control system comprising:
a motor including a rotor and a coil;
an H bridge circuit configured to control current flowing in the coil;
a motor control circuit configured to execute PWM (Pulse Width Modulation) constant current control of the H bridge circuit;
a time measurement circuit configured to measure a first time in which the H bridge circuit is in a first state; and
a first detection circuit configured to detect a low rotation or stop state of the rotor based on a length of the first time.

2. The motor control system according to claim 1, wherein
a plurality of the first times are included in a period in which the rotor executes a 1-step operation, and
the first detection circuit is further configured to determine that the rotor is in the low rotation or stop state in a case where the plurality of first times in the period in which the 1-step operation is executed are within a threshold range that is set based on a second time in a state in which the rotor stops.

3. The motor control system according to claim 2, wherein the second time is calculated by using a resistance component of the motor and a motor current.

4. The motor control system according to claim 2, wherein the time measurement circuit is further configured to measure the second time at a time when the motor control circuit executes control to set the rotor in a stop state.

5. The motor control system according to claim 1, wherein
the H bridge circuit includes:
a first high-side transistor including one end coupled to a power supply and an other end coupled to one end of the coil;
a second high-side transistor including one end coupled to the power supply and an other end coupled to an other end of the coil;
a first low-side transistor including one end coupled to the one end of the coil; and
a second low-side transistor including one end coupled to the other end of the coil and an other end coupled to an other end of the first low-side transistor and to a ground voltage line, and
in the H bridge circuit, in the first state, the first low-side transistor and the second low-side transistor are set in an ON state, or the first high-side transistor and the second high-side transistor are set in an ON state.

6. The motor control system according to claim 1, wherein the motor control circuit is further configured to increase current flowing in the coil in a case where the first detection circuit detects the low rotation or stop state of the rotor.

7. The motor control system according to claim 1, further comprising a second detection circuit configured to detect a vibration state of the rotor, based on the length of the first time.

8. The motor control system according to claim 7, wherein
a plurality of the first times are included in a period in which the rotor executes a 1-step operation, and
the second detection circuit is further configured to determine that the rotor is in the vibration state in a case where a state in which, among the plurality of first times in the period during which the 1-step operation is executed, two mutually neighboring first times are present within a threshold range and outside the threshold range, respectively, occurs two or more times, the threshold range being set based on a second time in a state in which the rotor stops.

9. The motor control system according to claim 8, wherein the second time is calculated by using a resistance component of the motor and a motor current.

10. The motor control system according to claim 8, wherein the time measurement circuit is further configured to measure the second time at a time when the motor control circuit executes control to set the rotor in a stop state.

11. The motor control system according to claim 7, wherein the motor control circuit is further configured to increase current flowing in the coil in a case where the second detection circuit detects the vibration state of the rotor.
